(19) United States
(12) Patent Application Publication
(10) Pub. No.: US 2004/0171371 A1
(43) Pub. Date: Sep. 2, 2004

(54) Automatic camera image transmittal system

(76) Inventor: Glenn Paul, Titusville, NJ (US)

Correspondence Address: Richard C Woodbridge, Synnestvedt Lechner & Woodbridge, PO Box 592, Princeton, NJ, 08542-0592, US

(21) Appl. No.: 10/475,271

(22) PCT Filed: Apr. 19, 2002
(86) PCT No.: PCT/US02/12649

Related U.S. Application Data
(60) Provisional application No. 60/285,476, filed on Apr. 20, 2001.

(51) Int. Cl. H04Q 7/00; G06F 17/60; G06F 15/16

(52) U.S. Cl. 455/414.4; 705/26; 709/229

(57) ABSTRACT

An automatic camera image transmittal system and method permits the safe, efficient and secure transmission of digital images (1012A) to a wireless network (1011) where they are archived and retrieved by authorized parties (1018). Initially the image is compressed and transmitted to the wireless network (1011) with a unique identifier, which authenticates the validity of the transmittal. The unique identifier includes a portion that is related to the specific camera used so that if the camera is stolen, the network will not accept images from that camera in the future. Fractal geometry technology is used to reconstitute the images (1012A) and improve picture resolution. The network (1017) can track the images (1012A) via the unique camera serial numbers and the preferences set by the customer (1100) at the time the camera is purchased. Information such as payment, printing, storage, and other data regarding the customer preference as well as passwords are also stored in the system (1010). The system and method enables customers (1100) to safely and securely transmit, store and retrieve digital images (1012A) without running out of film or having to connect to a computer or data card (1014).

### CROSS REFERENCE TO RELATED APPLICATIONS

This non-provisional application claims the priority of U.S. Provisional Application Serial No. 60/285,476, filed on Apr. 20, 2001 and incorporates herein, by reference, all the subject matter thereof.

### BACKGROUND OF THE INVENTION

1. Field of the Invention

This invention relates to a method and system for producing a digital image, transmitting said image to a wireless network and accessing said image from an archive of images stored on said wireless network.

2. Description of Related Art

Digital cameras have become increasingly popular and appear to be slowly replacing conventional chemical film-type cameras. At present the bulk of such cameras produce digital images by recording the digital image on a floppy disk or a Memory Stick™ and uploading that information to a personal computer (PC). Alternatively, the digital picture can be uploaded directly through a USB port. Software either provided by the camera manufacturer or commercially available is then used to edit the picture and print it on a color printer.

There are several disadvantages to the foregoing procedure. First, it requires a PC and the appropriate printing equipment. Such equipment can be costly and good quality color printers are rarely as good as commercial printers. Second, the memory of such devices is inherently limited so that a user can only store a relatively small number of photographs if resolution and clarity is important.

The general concept of creating a digital, or analog, image and transmitting it wirelessly to a remote location is known in other contexts. For example, wireless fax machines operate on a similar principle, as do remote television broadcasts. At present, however, there does not appear to be an economical, simple and convenient way of transmitting digital images to a remote location where they can be archived in a robust fashion and assessed for future printing or viewing.

In addition, the following specific prior art may be relevant to the present invention.

FotoNation, Inc. has issued a press release stating it will be granted patent protection for certain “critical” technology to allow users to connect digital cameras via telephones and cell phones to the Internet. The press release details three critical components, namely: 1) a method of configuring a camera through an external device and associating image information with images from the camera; 2) downloading to the camera configuration data by way of connection to and transmission through a telephone network to add functionality to the camera; and, 3) transferring the associated selected image data and digital image from the camera for external processing.

While the foregoing described application refers primarily to a camera and how it might be connected to the Internet via telephone, it does not appear to describe a complete, functional system that automatically tracks images, provides serial numbers and records customer preferences automatically.

The Eastman Kodak Company of Rochester, N.Y. produces a Kodak DCS Camera that can be employed with a system that is capable of receiving digital images from the camera. The system, however, provides for remitting digital images from the camera to the user's computer and not to a system that cannot only send images to a computer, but also to professional printing services, archiving services and includes the ability to track images and billing information efficiently and accurately.

U.S. Pat. No. 6,167,469 describes a wireless method for transporting digital images. The system described therein has the capability of capturing digital images and e-mailing the image to an e-mail server for e-mail distribution. The system, however, does not appear to provide for transactional delivery (assured, once, and only once), billing, serial number tracking, camera control, etc.

U.S. Pat. No. 6,181,954 describes a method and apparatus for image capture, compression and transmission of a visual image over telephonic or radio transmission systems. The disclosure primarily relates to the capture of high resolution (at least 640×800; also 800×600 and 1200×1600 or more) full color images from any NTSC source like video cameras, monochrome image intensifiers, monochrome night vision devices (such as FLIRs and the like). Depending upon the application, medium and low resolution may also be selected based upon user desires. It does not, however, offer a complete system, provide for dealing with transactional behavior, routing, billing, etc.

There are a number of other devices that can be found on websites on the World Wide Web.

For example, a small wireless camera having relatively low resolution and a short range is advertised at http://www.smarthome.com/7647ea.html.

Also, an organization known as Remote Video Diagnostics describes a digital imager that uses PAL, not for snapshots, but for the purpose of sending discreet photos and is found at http://www.sightlink.co.uk/wireless.htm.

Surveillance cameras are frequently of short range, generally not completely Internet compatible, and typically do not provide for enlarging software. Such surveillance cameras can be found http://www.x10.com/products/x10_vk45a.htm.

A 2.4 GHz wireless camera transmitter is advertised at http://64.132.25.173/servlet/cat/product/MVL8C.html. The main drawback, however, of every wireless camera is transmission type, ie, they are either based on close-range technologies like 2.4 GHz or Bluetooth; or, like the Kodak/Cellular Modem combination, required modem-to-modem connection (ie internet).

A wireless attachment for a video camera having a limited range of approximately 150 feet is described at http://www.samsontech.com/wireless/productsvml.html. It appears that almost every wireless camera available sends a video signal. Video, which sends multiple frames, is acquired at lower resolution per frame than a photo camera.

A short-range, low-resolution $75 wireless video camera for children is advertised at http://www.kbkids.com/genProduct.html.

Hewlett-Packard has introduced two point-and-shoot digital cameras, namely, the HP PhotoSmart 315 and the HP PhotoSmart 215, both targeted for first-time buyers. The HP PhotoSmart 315 is a 2.1 megapixel digital camera with a 2.5× digital zoom (for close-ups) and 1.8-inch high-resolution color LCD for instant preview and post-view of photos. The HP PhotoSmart 315 also provides wireless printing via HP JetSend infrared technology. The camera ships with an 8 MB Compact Flash card and is compatible with both PC and USB-connect Macintosh systems. See, in particular, the following web-site: http://maccentral.macworld.com/news/001002.hp.s.html. The foregoing, however, are very local in that images are sent to a local printer and not to the WorldWide Web. See http://e-services.hp.com/newsevents/press

The bulk of the digital image business is focused on local, short distance wireless, or is waiting for, Bluetooth or broadband to become ubiquitous.

Additional, possibly relevant, information may be obtained from the Lightsurf press release of Mar. 19, 2001 available at http://www.lighsurf.com/press/releases/pr_{—}0211901.html. Further discussions can be found at the press release entitled “Motorola and Lightsurf” available at http://www.lightsurf.com/press/releases/pr_{—}2070001.html.

### SUMMARY OF THE INVENTION

Briefly described, the invention comprises an image network referred to as a Click & Deliver system or network that permits amateur and professional photographers to directly send any or all digital images from their camera by pushing a button any or all digital images via a wireless network, be informed whether uploads are successful, and be authenticated by the network to prevent unauthorized usage. By use of this technology, images can be condensed to be sent swiftly over wireless and Internet lines. The transmission is transactional in nature, ensuring one, and only one, delivery of each image. The technology described, using fractal geometry can reconstruct the images into satisfactory images (otherwise the amount of data needed for each image is too large given current technology to be sent easily). The novel network can track images via unique camera serial numbers and customer set information at the time of camera purchase for payment, printing, storage and shipment and other processes as well as set a password to change such information. The network can also use passwords to prevent cameras reported as stolen from sending images via the network, to shut down cameras via encoded software and make such information available to non-Internet photo developers, making stolen cameras worthless.

The invention described herein will further enable consumers to have limitless developed pictures without ever running out of film or dropping off and picking up film, or connecting to a computer by a wire or data card.

The invention may be more fully understood by reference to the following drawings.

### BRIEF DESCRIPTION OF THE DRAWINGS

FIG. 1A illustrates a simplified schematic of the steps of the invention according to the preferred embodiment thereof.

FIG. 1B illustrates a more detailed version of the steps of the invention showing positive authentication and authorization.

FIGS. 2A and 2B illustrate the processing steps of the high-level use case mode.

FIG. 3 further illustrates the PhotoSet Manager steps of the system.

FIG. 4 comprises a block diagram schematic of the overall system deployment diagram in which nodes represent one or more physical devices, components represent software systems and alternatives are enumerated in box notes, or within the components shown.

FIG. 5A illustrates an alternative embodiment of the invention in which a camera phone sends wireless photos to a server where the photos can be accessed and paid for by purchasing in real time.

FIG. 5B illustrates the steps in the method for the embodiment shown in FIG. 5A.

### DETAILED DESCRIPTION OF THE PREFERRED EMBODIMENT

During the course of this description like numbers will be used to identify like elements according to the different figures, which illustrate the invention.

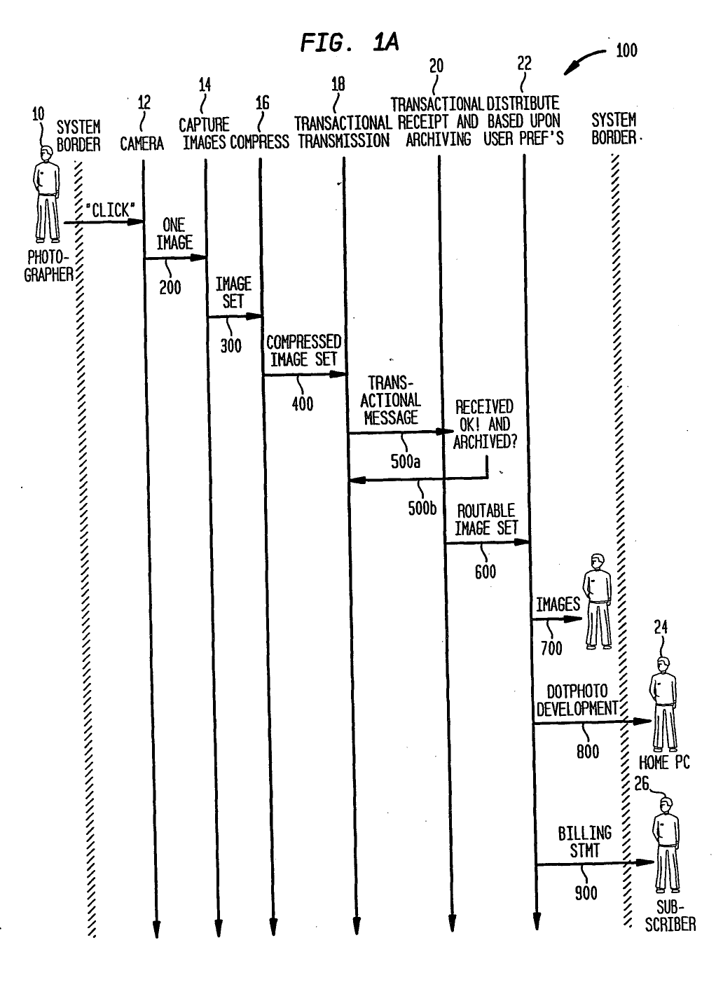

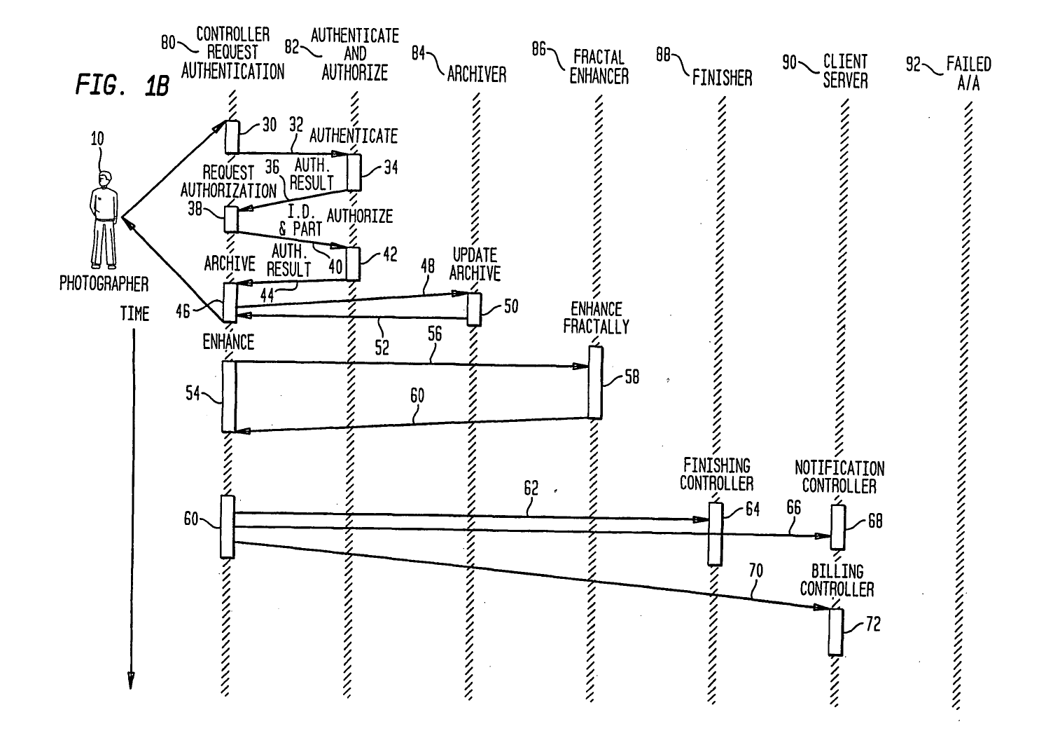

A simplified version of the invention 100 is illustrated in FIG. 1A. Initially the photographer or user 10 acquires a digital camera 12, which has a unique serial number identifier 32. At the time of purchase, the camera owner 100 may fill out a form with preferences with regard to image management (which image developer, how much to charge credit cards each month or for each set of images, where to send the prints), what level of services they require (professional or amateur), which level of “assured” delivery is required, archiving services, and a secret password associated with the camera and its unique serial number. When the consumer 10 takes a photo or a series of photos, the user 10 will typically press a single button on their camera 12.

The camera 12 will compress in step 16 the image data 14 in to a small file so that it can be uploaded onto a wireless carrier for transmittal 18. Software and technology is presently commercially available to compress the image set. The mode of transmission 18 includes the capability to find the appropriate wireless method for transmission in the area, direct web, radio, phone lines, or satellite depending upon speed and cost and try to transmit the images 14 until it has successfully transmitted the images 14. When notification 20 of the successful transmittal has occurred, the camera 12 will automatically delete transmitted files thereby freeing space for new images. The system 100 is scalable (i.e. the mobile application may integrate thousands or even millions of users 10); will provide security (authentication of users, confidentiality, non-repudiation of transactions, etc.); and is robust (transactions need to be executed exactly in spite of poor network coverage or failures). The system 100 is also flexible in order to accommodate different transmission technologies including, but not limited to, SMS, GSM, GPRS, Bluetooth, Infrared) and interaction styles (synchronous, asynchronous, transactional, one-to-one, or many-to-many).

The system 100 hardware includes wireless transmission chips that may connect directly to the web or to radio or satellite but excludes telephone. Extended Short Messaging Service (ESMS) for digital content may also be used as a RF mechanism, bypassing the phone system entirely. Other technologies may be available on a global basis. The camera 12 should be “Transport and Network Agile” to allow a choice among competing, available networks/transports, including protocols such as Bluetooth. Agile Camera 12 may choose among competing networks/transports based upon SLA criteria.

After the image is received and archived 20, it is distributed according to the user's 10 preferences 22, which may be by a wireless distribution, or distribution to a home PC 24 followed by a billing statement 26. Notification to the user 10 can be at a multitude of levels including, but not limited to, notification that images have been sent to confirm delivery in the case of professional photographers.

FIG. 1B illustrates, in more detail, how the system 100 determines positive authentication and authorization. As illustrated in FIG. 1B the user 10 makes an authorization request 30 of the controller 80, which transmits an I.D. 32 to the authentication and authorization equipment 82. If the I.D. request 32 is authenticated in step 34, the result 36 is transmitted back as authorization 38.

Next, the I.D. and authentication permission 40 is forwarded to 82 for authorization 42, the results of which 44 are transmitted back and received as permission 46. The digital image 48 is then transmitted to archiver 84 where it is archived as step 50 and a confirmation 52 is transmitted back to controller 80. The user 10 may wish to enhance 54 the digital photograph at which point a request 56 is transmitted to the fractal enhancer 86 where upon the enhancement 58 is performed and an acknowledgement 60 is transmitted back to 54. Once those steps have been completed 60, notification 62 is sent to the finishing controller 88 resulting in completion 64 of the finishing process. Another notification 66 is sent to client server 90 notifying the controller 68 that the process is complete. Finally, a notice 70 is sent to the billing controller 72 of the client server 90 to forward the bill to the user 10. Alternatively, if the process steps are not satisfactorily completed a failure notification 92 is generated.

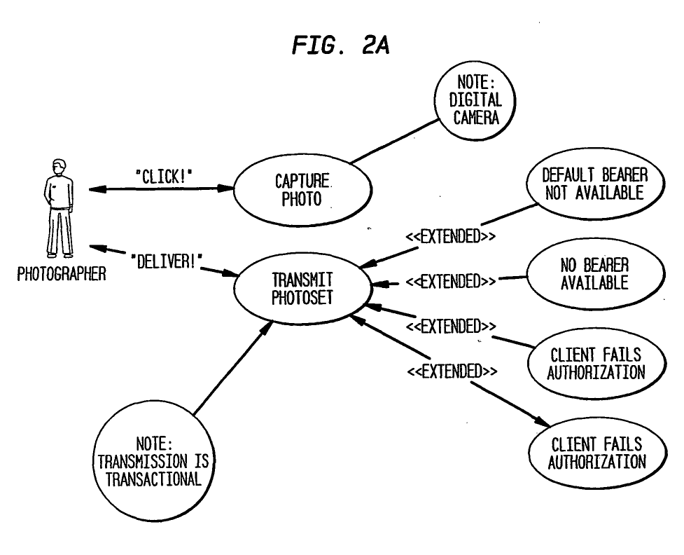

FIGS. 2A and 2B illustrate the steps in further detail indicating what happens if there is a failure of any of the steps to take place satisfactorily.

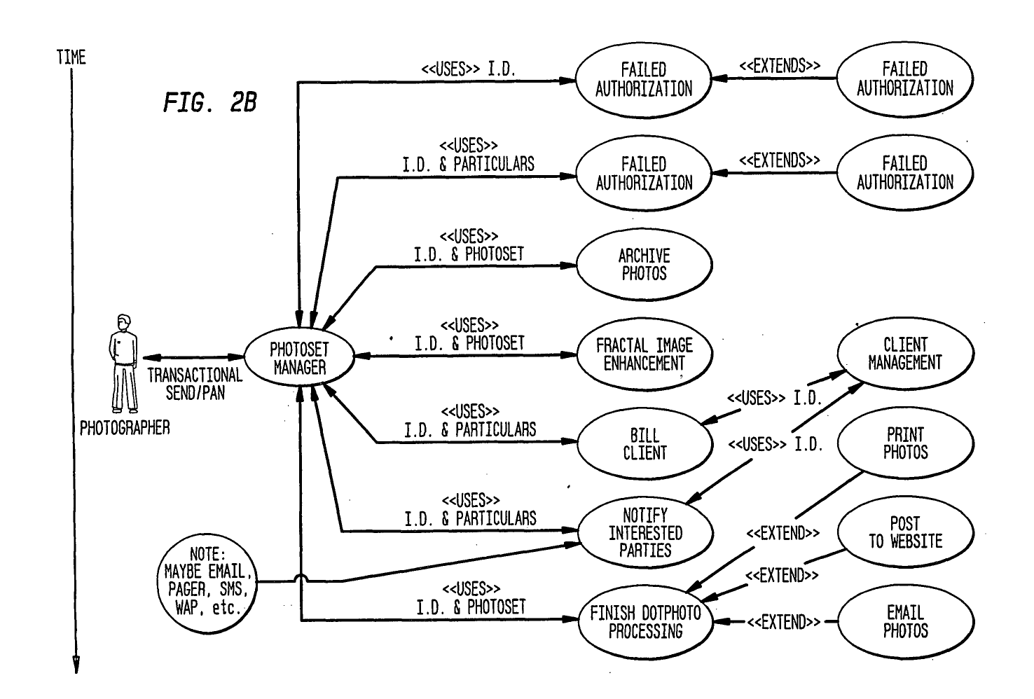

FIG. 3 illustrates the use set of FIGS. 2A and 2B in a slightly alternative embodiment.

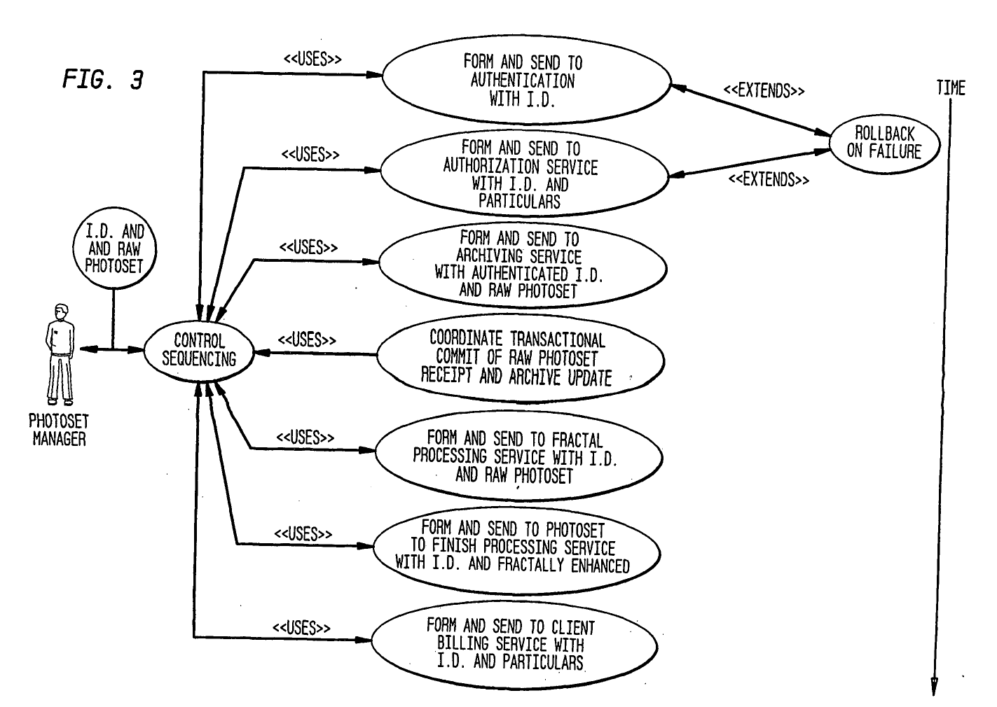

FIG. 4 illustrates the system deployment 100 in which nodes represent one or more physical devices; components represent software systems; and alternatives are enumerated in box notes or within the components.

The system 100 may be further understood as follows. The network or system 100, as shown in FIGS. 1B through 4.will check identifying serial numbers to determine if the user 10 is entitled to use the network 100, will check the status of the account (ie, how much money is authorized and on hand or charge credit card for pay-as-you-go customers), and after verification, will permit successful transmittal and notify the customer 10. Authentication of users also prevents “denial-of-service” attacks by third parties. In cases where access is attempted by cameras 12 reported stolen, the system 100 may attempt to send a message to the camera 12 shutting it down via encoded software until returned to the owner 10.

After authentication and authorization, the network 100 will transmit the images, based upon previous information, to a selected printer, to archives if requested; and, monitor information to ensure safe delivery.

The receiving end of the network 100 includes the capability, in the form of software, at the printer to take images 14, use fractal geometry, and reconstitute the images 14 into satisfactory photographic images of acceptable quality to consumers 10. Such data compression and expression are generally desirable to make upload and download times reasonable and to ensure sufficient storage capabilities given the billions of images taken each month by amateur and professional photographers 10.

Images may also be stored in archives for consumers 10, where they can call up their images in their personal directories. Such images may be maintained either for a limited period after transmittal without charge or for unlimited periods upon payment of a fee or other consumer agreement.

A photo printer receives the images and prints them in a format pre-selected by customers 10 and mails printed images to customers 10 at pre-selected addresses. At the time of transmittal, agreed upon fees will be transferred to the printer's account and charged to the customer 10. Confirmation of payment will be sent to the customer 10 and the photo printer as well as stored in the system 100's client files.

The system 100 includes a number of unique features. The system 100 will allow customers 10 to send their photographic images 200 or 300 over a wireless network with a click of a camera button thereby storing their images and/or receiving printed photos in the mail in a few days. The system 100 may also automatically not friends and associates of the user 10 by e-mail when a group of new images 300 has arrived for viewing. Such images will be managed and condensed 400 without the loss of acceptable image quality via the network system 100, then saved, delivered and charged as per the customer's instructions. Customers 10 will be informed via the network that the images 200 and 300 have been successfully delivered 500a and 500b. Camera theft will be cut down by use of the unique serial number thereby preventing stolen cameras 12 from using the network 100 and by use of software that can shut down the camera 12 via data signals when activated by the network 100 when a camera 12 is recorded stolen. The preferred camera 12 of the system 100 may be “conversational” with the system 100 telling the camera 12 that a good receipt was made (500a and 500b), or a picture 200, 300 was rejected due to an authorization problem, corruption, etc. The transactional components 500a and 500b enable this “conversational” feature.

The present invention 100 also includes substantially improved security capability. At the time of purchase the user 10 is requested to provide the unique identification number of the camera 12 and is given a unique password as previously described. When the camera 12 is sold or given away by the original purchaser 10, the information is updated via the unique password given to the original owner 10 at time of purchase. Such changes can be made over toll free 800 or 888 numbers or directly on the system 100 network through the World Wide Web. In cases where the camera 12 is reported stolen, the network 100 can monitor attempts to use the camera 12 on the network 100 and prevent and disable the camera 12 thus making stolen cameras 12 worthless. If all images have unique serial numbers attached to them, it is possible to alert photo processors to databases of stolen cameras to improve security for all owners 10. Authentication of users 10 also prevents “denial-of-service” attacks by third parties. This might occur, for example, where a large number of rouge devices are programmed to send large quantities of fake photo data to the system 100 in an attempt to overwhelm its processing network. Authentication can take place on the outskirts of the network 100. These “velvet rope” devices will only let valid binary photo data processing requests to the network 100.

In general, authorization is used to determine what rights the user 10 has within the scope of available rights (i.e., services) offered by the system 100. Rights will depend upon the subscription plan and, SLA, class of user, etc. There are a variety of different types of authorizations by the user 10 such as, for example, the right to user registered data, what the chosen parameters are, how much money is left in a users account, whether the user is professional or amateur, whether photos can be transmitted to press agencies or other professional organizations, etc.

Images 200, 300 can be stored, their graphics enhanced by fractal geometry, and sound and/or text may be added for both consumers and professional photographers and subsequently routed 600 to be printed 700 or otherwise viewed 800. Thereafter, the subscriber 26 is billed 900.

There are a number of information responses that the system 100 can provide to the user 10 or to other parts of the system 100. For example, there can be an acknowledgement response (ACK) to indicate that the image was uploaded, or telling the sender 10 that images were received 500b, were sent, estimated time of delivery, cost of order, and/or delivery address. It is also possible that negative acknowledgements (NAK) may be sent to the camera 12, indicating a problem of some sort. The nature of the problem may determine the behavior of the camera 12 or the behavior of the user 10 (e.g., automatic retry, delayed retry, identifies the user as an unknown individual, etc.).

Drop down menus are another type of enhancement and feature unique to the system 100. For example, customers 10 would receive a drop down menu via the World Wide Web, similar to that found on cellular phones, when sending images whereby the user 10 could scroll down and select choices with regard to processing, delivery, authorization of additional charges to credit cards, size of pictures ordered, types of prints (glossy, flat, borderless, date-stamped, nature of customer on pictures, etc.). The drop down menu would preferably be a physical element of the camera 12, or, could be sent directly to users' 10 web/wireless application protocol (WAP) enabled cellular phone. In the case of a relatively inexpensive camera 12, this could be a useful feature.

Customize controlled routing is another relatively unique and useful feature of the invention. According to the preferred embodiment of the invention, the data on file is set by the customer and limited by their authorizations and payment levels. For example, a commercial photographer may want a set of photos to be routed to Associated Press another set to New York Magazine. This routing could be controlled by instrumentation on the camera 12, or by an external (not a private phone) WAP phone link to the system 100, or by other mechanism.

An alternative embodiment of call routing would be that a fee could be charged either by the transmission of a single image 200 or by the transmission of a full set of images 300 for maintaining the network 100, handling payments, and directing images 200, 300 to various printing concerns. Such a fee is presently estimated to be in the range of 2 to 5 cents per image. Another routing customization and enhancement takes into account that customers 10 may or may not use the Internet to manage their pictures of their account. Non-technical customers 10 may call a toll free 800 or 888 number to establish their account and preferences, for instance, which credit card to be charged, how many pictures to accumulate before shipping an order, the maximum number of photos to allow, or an option for double prints. On the other hand technically capable customers 10, who are familiar with the Internet may set their own preferences via the Internet, and may participate in more complex image management functions including selling, e-mailing, and editing their photographs.

Another unique feature of the system 100 is the ability to perform a sophisticated digital image management. Specifically, the network 100 can enhance images via proprietary technology, such as the use of fractal geometry, in order to accommodate the use of lower price cameras and their relatively low resolution images and makes them printable as standard sized photos. Moreover, the technology is available to enlarge files to appropriate sizes, currently 1830×1230 resolution for 4×6 images, using software to smooth images as they are enlarged and to eliminate pixellation. The system 100 also calls for the ability to compress images to reduce download and upload times and for data storage purposes.

Further alternatives of the unique digital image management of the system 100, include the ability of the system 100 to automatically upgrade customers 10 when appropriate from prevailing, relatively slow Internet speeds of 56K to cable, DSL, T1 and other relatively new wireless connections that will allow individuals to send images quicker from point-to-point. It is also possible to add various watermarks, graphics, and titles to the photos that can be set in the initial customer preferences and profiles via the Internet web-site or by toll free 800 or 888 numbers of a reasonable service charge. It is further possible to upload images to a specific photo image printer based upon the customer's choice, price, speed of delivery, etc. via a computer network that monitors the system 100 constantly for factors affecting image printing and delivery. For example, if a printer is overloaded or, if a printing station is located in the same state as a user, it might make better sense to use that printer rather than one across the country. The system 100 includes the alternative ability to direct images to be stored either on the system 100 web-site or at the photo developer's site. The images may be stored initially free for a period of time and thereafter payment of a fee or rent might be charged after, for example, 30 days. Lastly, the system 100 has the capability to alert customers 10 that digital storage rights are about to expire unless the storage fee is paid.

Finally, the system 100 includes an enlarging and smoothing processor (ESPA) that preferably comprises an array of micro-processors using fractal geometry to enlarge smaller prints so that they can produce acceptable 4×6 inch prints.

Online Image-Selling Sub-System Connected to a Camera Phone

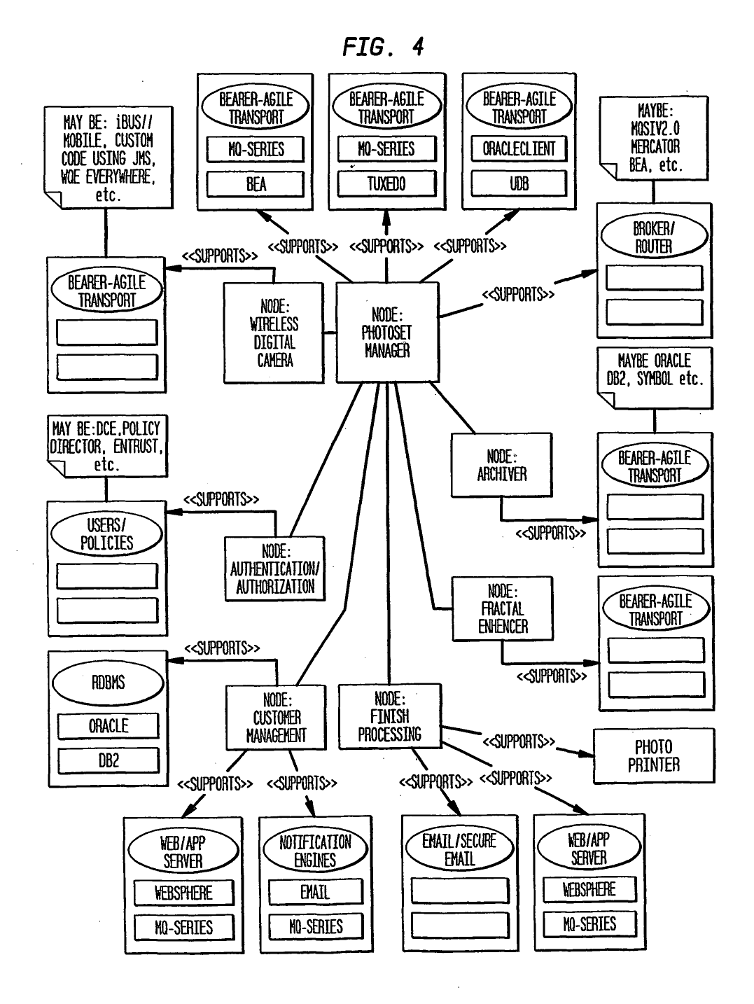

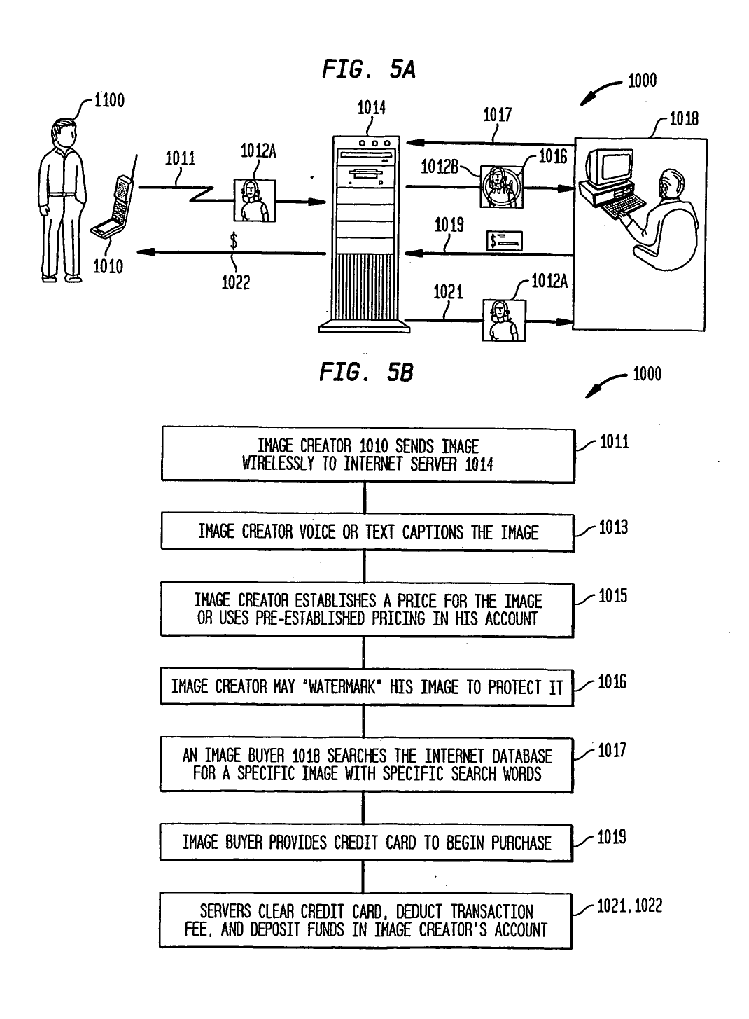

As shown in FIGS. 5A and 5B, users 1100 of Camera-Phones 1010 can also sell their images 1012A immediately after they create the image. This creates a market in up-to-the-minute images of sporting or national events, and may also be used by news organizations or free lancers as another income source.

The Image-Selling System 1000 is a sub-system, or alternative embodiment, of the core system 100. Once the Camera-Phone 1010 has uploaded the image 1012A directly to the file servers 1014, the user 1100 can caption 1013 the photo 1012A so that it is searchable by anyone 1018 on the web or file server 1014. The caption 1013 may be created on the camera-phone keyboard using the standard phone-keyboard alphabetic encoding techniques (Pressing the “2” key twice yields the second letter of the “2” key—a “B”), or the photographer 1100 may speak into the phone 1010 to send a voice file that follows the image 1012A. The server 1014 runs a voice recognition program that translates the voice pattern into text and inserts that text as the caption of the photo 1012A.

Once the photo is captioned 1013, other users 1018 can find the photo 1012A among millions of other images by searching the database for keywords or by browsing recent public image uploads. In special situations like national events, server 1014 will create web pages that feature images as they stream in from the event.

The image producer 1100 can watermark 1015 his or her image 1012B by specifying “Watermark all images” in his “Membership Options”, or by designating a specific image for watermarking prior to upload to the server 1014. Watermarking adds the word ‘proof’ to an image 1012B when viewed by a guest 1018 (anyone who is not the owner of the image). This prevents viewers 1018 from stealing clean images directly from the computer screen using a screen capture.

Image producers can sell their images 1012A under several customizable online contracts: for instance, (1) Illustrate a PowerPoint presentation—$5; (2) Illustrate an advertisement with a viewership up to 50,000 people—$25; and, (3) Illustrate a campaign with up to 1 million impressions—$100. The contract is between the buyer 1018 and the seller 1100; the system 1000 serves as the tool to facilitate the sale. The buyer 1018 enters his or her credit card 1019 to make the purchase, and the web server 1014 clears the credit card 1019, deducts the transaction fee, and deposits the money 1022 in the seller's online account such as Paypal. After payment 1019 is made, a clean or usable copy (i.e. without watermarks) of the photograph 1012A is forwarded 1021 from the web or server 1014 to purchaser 1018 in a format he or she can use. If the seller 1100 has no online account, the system 1000 sends an e-mail notifying the seller 1100 that it is trying to deposit funds, and will attempt again upon response to the e-mail.

The transaction is low-cost and “frictionless” because it does not require human interaction: the system 1000 connects buyers 1018 and seller 1100 in different locales but with a common desire to produce and use a certain image 1012A. Another advantage of the system 1000 is that it can operate in real time. For example, in the event of a natural disaster, the photographer 1100 can take the photograph 1012A, caption it, send it to a server wirelessly, watermark it, have it reviewed by purchaser 1018, and sell it and get paid all within real time minutes, e.g. 5-10 minutes, of the original event. Alternatively, the photo 1012A can go to an auction site like e-Bay where it is auctioned in substantially real time and the user 1100 gets a fair price for his efforts. All of the above produces a result where the photographer has more incentive to take useful and interesting photos 1012A and will get paid relatively promptly while the public benefits from more photos 1012A taken closer to the actual event and for which the purchaser has paid a fair price. Everyone benefits.

While the invention has been described with reference to the preferred embodiment thereof, it will be appreciated by those ordinary skilled in the art that modifications can be made to the various different parts of the system and the method steps incorporated therein, without departing from the spirit and the scope of the invention as a whole.

What is claimed is:

1. An imaging method for use with a wireless network comprising the steps of:
a. taking at least one digital image with a digital camera;
b. transmitting an authentication request to said wireless network for access to said wireless network, said authentication request including an identification code that is unique to said camera;
c. authorizing transmittal of said at least one digital image to said wireless network if said unique identification code is authenticated by said wireless network; and,
d. transmitting said at least one digital image to said wireless network after authorization is obtained.

2. The method of claim 1 further comprising the step of:
e. compressing said at lease one digital image prior to said transmitting step d.

3. The method of claim 2 further comprising the step of:
f. archiving said at least one digital image transmitted to and received by said wireless network.

4. The method of claim 3 further comprising the step of:
g. improving the resolution of said at least one digital image received by said wireless network using fractal geometry algorithms.

5. The method of claim 4 further comprising the step of:
h. forwarding said at lease one digital image to a photo finishing means; and,
i. sending a notice to a user of said digital camera that the digital images have been printed.

6. The method of claim 5 further comprising the step of:
j. sending a bill to the user of step i for services rendered.

7. The method of claim 6 further comprising the step of:
k. denying access to said wireless network if said unique identification code fails to match an authorized digital camera means.

8. The method of claim 7 further comprising the step of:
l. sending a signal back to said digital camera if access is denied in step k above and disabling said digital camera as a result thereof.

9. An imaging system for use with a wireless network:
a camera means for producing a digital image as a code having at least an image section and a unique identification section;
transmitting means for transmitting said digital image to said wireless network; and,
archiving means associated with said wireless network for archiving said digital image if said unique identification code section authenticates the validity of said transmitted digital image and authorizes said archiving means to accept said digital image for storage.

10. The system of claim 9 further comprising:
image compressing means for compressing said digital image prior to transmittal to said archiving means.

11. The system of claim 10 further comprising:
security means for deactivating said camera means if said system determines said camera means has been stolen.

12. An image selling method for a user with a wireless device equipped to take and transmit digital photographs comprising the steps of:
a. creating an image with said wireless device;
b. sending it wirelessly to a server;
c. making said image available for inspection by a potential purchaser;
d. licensing said image to said potential purchaser whose credit has been verified;
e. transmitting said image to said purchaser in a usable form following step d above, and,
f. crediting the creator of said image with a least some of the proceeds of said license.

13. The method of claim 12 further comprising the step of:
g. adding a voice caption to said image prior to step b.

14. The method of claim 13 further comprising the step of:
h. adding a watermark to said image.

15. The method of claim 14 wherein said wireless device comprises a cellular phone equipped with a digital imaging device.

16. The method of claim 15 wherein steps a-h take place substantially within real time.

17. An image selling system comprising:
a. wireless means for creating an image and sending it wirelessly to a server;
b. server means for receiving said image making said image available for inspection by a potential purchaser, verifying the credit of said potential purchaser, forwarding a useable version of said image to said purchaser after the purchaser's credit has been verified and forwarding at least a portion of said credit back to the owner of said wireless means.

18. The system of claim 17 further comprising:
c. means for adding a voice caption to said image.

19. The system of claim 18 further comprising the step of:
d. means for adding a watermark to said image.

20. The system of claim 19 wherein said wireless means comprises a cellular phone equipped with a digital imaging device.

21. The system of claim 20 wherein said image is created and said payment is credited to said owner of said wireless means substantially within real time.

22. The method of claim 1 further comprising the steps of:
m. receiving notification of archiving of said transmitted digital image.
n. deleting said digital image from said digital camera on receipt of said notification of archiving.

23. The system of claim 9 further comprising:
means for deleting said digital image from said camera upon notification from said archiving means.
